(19) United States
(12) Patent Application Publication
(10) Pub. No.: US 2025/0125417 A1
(43) Pub. Date: Apr. 17, 2025

(54) ALL SOLID-STATE ELECTRODE ASSEMBLY

(71) Applicant: LG Energy Solution, Ltd., Seoul (KR)

(72) Inventors: Sung Hyun Nam, Daejeon (KR); Dong Kyu Kim, Daejeon (KR)

(21) Appl. No.: 18/988,406

(22) Filed: Dec. 19, 2024

Related U.S. Application Data
(63) Continuation of application No. PCT/KR2024/096140, filed on Sep. 13, 2024.

(30) Foreign Application Priority Data
Sep. 15, 2023 (KR) 10-2023-0123075
Sep. 11, 2024 (KR) 10-2024-0123904

(51) Int. Cl. H01M 10/0565; H01M 4/02; H01M 4/62

(52) U.S. Cl. CPC H01M 10/0565; H01M 4/622; H01M 2004/028

(57) ABSTRACT

An electrode assembly includes a positive electrode; a negative electrode; and an electrolyte layer between the positive electrode and the negative electrode, wherein the electrolyte layer comprises: a polymer in the form of a network including a polyethylene oxide-based copolymer with cross-linkable functional groups, at least some of which form cross-links; a ceramic compound; and a polar compound, wherein the polar compound is contained in the network, and wherein the positive electrode comprises a positive electrode active material and a binder comprising the polymer including the polyethylene oxide-based copolymer having the cross-linkable functional groups.

### REFERENCE TO RELATED APPLICATIONS

The present application is a continuation of PCT/KR2024/096140, filed on Sep. 13, 2024, which claims priority to and the benefit of Korean patent application nos. KR10-2023-0123075 filed on Sep. 15, 2023 and KR10-2024-0123904 filed on Sep. 11, 2024, the entire contents of which are incorporated herein by reference.

### TECHNICAL FIELD

The present invention relates to an electrolyte, and an electrode assembly including the same.

### BACKGROUND ART

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

Lithium-ion batteries that use a liquid electrolyte have a structure in which the cathode and anode are divided by a separator, so if the separator is damaged by deformation or external impact, a short circuit may occur, which can lead to risks such as overheating or explosion. Therefore, the development of a solid electrolyte that can ensure safety in the field of lithium-ion secondary batteries can be said to be a very important task.

Lithium secondary batteries using solid electrolytes have the advantage of increasing the safety of the battery, improving the reliability of the battery by preventing electrolyte leakage, and making it easy to manufacture thin batteries. In addition, lithium metal can be used as a negative electrode, which can improve energy density. Accordingly, it is expected to be applied to small secondary batteries as well as high-capacity secondary batteries, such as those for electric vehicles, and is attracting attention as a next-generation battery.

Among solid electrolytes, polymer solid electrolytes can be made of ion-conducting polymer materials, and can optionally be used in the form of a solid electrolyte that mixes these polymer materials with inorganic materials.

A conventional solid electrolyte is manufactured by dispersing inorganic powders such as oxide-based ceramics in a polymer matrix. Such a conventional solid electrolyte has higher ignition and combustion stability, and has higher ion resistance, compared to existing liquid electrolytes and polymer solid electrolytes. Although having the advantage of conductivity, the oxide-based ceramic particles within the polymer matrix can exhibit difficulties with dispersibility and optimization of the physical properties of the polymer matrix. In particular, when using a highly crystalline polymer such as polyethylene oxide (PEO) as a matrix, there is a problem in that it is difficult to manufacture a solid electrolyte with improved ionic conductivity. In other words, due to the high crystallinity of the PEO polymer, the chain mobility of the polymer is inhibited and there are restrictions on the movement of lithium ions inside the polymer solid electrolyte. As a result, there is a limit to improving the ionic conductivity of the polymer solid electrolyte. For example, it has proven difficult to achieve an ionic conductivity of 1 mS/cm or more at room temperature with conventional composite solid electrolytes.

### SUMMARY OF THE INVENTION

The present invention provides an electrolyte showing improved ionic conductivity, as well as other benefits and advantages that will be apparent to those persons skilled in the art based on the present disclosure. The present invention also includes a solid electrolyte, a composite electrolyte, a composite solid electrolyte, as well as a positive electrode comprising the inventive electrolyte. In addition, the present invention includes an electrode assembly exhibiting improved ionic conductivity and other beneficial properties and functionality.

It should be understood that the various individual aspects and features of the present invention described herein can be combined with any one or more individual aspect or feature, in any number, to form embodiments of the present invention that are specifically contemplated and encompassed by the present invention. This includes any combination of the various features recited in the claims, regardless of their stated dependencies.

According to certain aspects, an electrode assembly is provided including: a positive electrode; a negative electrode; and a electrolyte layer between the positive electrode and the negative electrode, wherein the electrolyte layer comprises: a polymer in the form of a network including a polyethylene oxide-based copolymer with cross-linkable functional groups, at least some of which form cross-links; a ceramic compound; and a polar compound, wherein the polar compound is contained in the three-dimensional network, and wherein the positive electrode comprises a positive electrode active material and a binder comprising the polyethylene oxide-based copolymer having the cross-linkable functional groups.

The electrode assembly as described herein, wherein the polar compound is optionally in a gaseous state and dispersed between cross-linked polymer chains, or is adsorbed or bound to the surface or interior of the polymer chains.

The electrode assembly as described herein, wherein at least some of the cross-linkable functional groups optionally form cross links with each other through a cross-linking agent.

The electrode assembly as described herein, wherein the cross-linkable functional groups are optionally connected to a main chain of the polyethylene oxide-based copolymer via a direct bond or a linker having a 1 to 10 carbon number, and wherein the cross-linked functional groups are optionally selected from the group consisting of: a hydroxyl group, a carboxyl group, an isocyanate group, a nitro group, a cyano group, an amine group, an amide group, an epoxy group and an allyl group.

The electrode assembly as described herein, wherein the linker is optionally an alkylene linker or an alkylene oxide linker.

The electrode assembly as described herein, wherein the electrolyte optionally has an ionic conductivity of 0.95 mS/cm or more at 25° C.

The electrode assembly as described herein, wherein at least one of the electrolyte layer or the positive electrode optionally further includes a lithium salt.

The electrode assembly as described herein, wherein the lithium salt is optionally included in an amount of 25 to 45 parts by weight, based on 100 parts by weight of the polyethylene oxide-based copolymer containing the cross-linkable functional group.

The electrode assembly as described herein, wherein the polyethylene oxide-based copolymer is optionally a copolymer comprising repeating units of the following formulas 1 to 3:

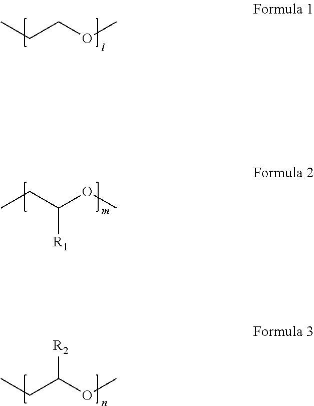

wherein in the above formulas 1 to 3, R₁ represents —CH₂—O—(CH₂—CH₂—O)ₖ—R₃, k is 0 to 20, and R₃ represents an alkyl group having 1 to 5 carbon atoms, R₂ is a group in which at least one cross linkable functional group selected from the group consisting of hydroxyl group, a carboxyl group, an isocyanate group, a nitro group, a cyano group, an amine group, and an amide group, an epoxy group and an allyl group is bonded to a main polymer chain of the polyethylene oxide-based copolymer via a direct bond or a linker having a 1 to 10 carbon number, and l, m, and n are the number of repetitions of the repeating unit, where 1 and n are each independently an integer from 1 to 1,000, and m is an integer from 0 to 1,000.

The electrode assembly as described herein, wherein the linker is optionally an alkylene linker or an alkylene oxide linker.

The electrode assembly as described herein, wherein the polyethylene oxide-based copolymer is optionally a copolymer comprising repeating units of Formula 4:

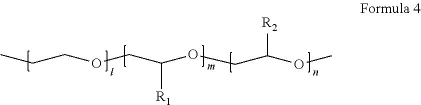

wherein R₁ and R₂ are the same or different from each other, and each is a group having at least one cross linkable functional group selected from the group consisting of: a hydroxyl group, a carboxyl group, an isocyanate group, a nitro group, a cyano group, an amine group, and an amide group, an epoxy group and an allyl group, and l, m and n are each independently an integer from 1 to 1000.

The electrode assembly as described herein, wherein R₁ and R₂ are optionally different from each other.

The electrode assembly as described herein, wherein R₁ and R₂ are optionally different from each other, and one of R₁ and R₂ optionally includes a cross-linkable functional group, and the other of R₁ and R₂ optionally includes an oligomer acting as a plasticizer.

The electrode assembly as described herein, wherein the copolymer has a weight average molecular weight (Mw) of 100,000 g/mol to 2,000,000 g/mol.

The electrode assembly as described herein, wherein the content of the polar compound is optionally 0.1% by weight or more and less than 10% by weight, based on the total weight of the solid electrolyte layer.

The electrode assembly as described herein, wherein the polar compound optionally includes at least one selected from the group consisting of carbonate-based compounds and sulfonyl-based compounds.

The electrode assembly as described herein, wherein the polar compound optionally comprises at least one selected from the group consisting of ethyl methyl carbonate (EMC), dimethyl carbonate (DMC), diethyl carbonate (DEC), ethylene carbonate (EC), propylene carbonate (PC), vinylene carbonate (VC) and sulfolane.

The electrode assembly as described herein, wherein the ceramic compound comprises an oxide-based solid electrolyte of lithium metal oxide or lithium metal phosphate.

The electrode assembly as described herein, wherein the ceramic compound is optionally chosen from the group consisting of lithium-lanthanum-zirconium oxide (LLZO), lithium-silicon-titanium phosphate (LSTP), lithium-lanthanum-titanium oxide (LLTO), lithium-aluminum-titanium phosphate (LATP), lithium-aluminum-germanium phosphate (LAGP), and lithium-lanthanum-zirconium-titanium oxide (LLZTO).

The electrode assembly as described herein, wherein the ceramic compound is optionally in the form of particles having a diameter of 100 nm to 1000 nm.

The electrode assembly as described herein, wherein the ceramic compound is optionally included in an amount of 10 parts by weight to 100 parts by weight, based on 100 parts by weight of the polyethylene oxide-based copolymer.

The electrode assembly as described herein, wherein the electrolyte layer optionally has an activation energy deviation (ΔEₐ) by temperature defined by Equation 1 below of 0.03 eV or less:

$$Δ {E}_{a} = {{E}_{a}}^{LT} - {{E}_{a}}^{HT} , \qquad Equation 1$$

energy of the electrolyte layer at −40° C. to 10° C., Eₐ^{HT} is the activation energy of the electrolyte layer from 10° C. to 80° C., ΔEₐ represents the activation energy deviation by temperature, which is defined as the difference between the two activation energies.

The electrode assembly as described herein, wherein the electrolyte layer optionally has an activation energy deviation (ΔEₐ) by temperature defined by Equation 1 of 0.02 eV or less.

The electrode assembly as described herein, wherein the positive electrode optionally satisfies the thickness strain defined by Equation 2 below when rolled on both sides using a roll:

$$\frac{d}{{d}_{0}} = C {( \frac{{δ}_{0}}{δ} )}^{- n} \qquad Equation 2$$

wherein in Equation 2 above, δ₀ and d₀ indicates the initial roll gap and initial thickness of the positive electrode before rolling, δ and d represents the roll gap and the thickness of the positive electrode during rolling, C is a constant determined by regression analysis.

The electrode assembly battery as described herein, wherein the negative electrode optionally comprises a metal layer.

A battery optionally comprising the electrode assembly as described herein.

An electrolyte formed according to the principles of the present invention includes a predetermined composite solid electrolyte layer manufactured by vapor deposition of a polar compound. This solid electrolyte layer maintains the original structural characteristics of the polymer without deformation or destruction of the polymer chain, while improving the mobility of the polymer chain and uniformly distributing ceramic particles in the electrolyte, and thus exhibits improved ionic conductivity.

In addition, the electrolyte can improve the ionic conductivity and mechanical properties of the polymer electrolyte by including a very small amount of a polar compound in the gaseous state.

According to further aspects, an electrode assembly which includes the inventive electrolyte layer as well as an anode comprising the same polymer electrolyte material as a binder, exhibits excellent charge/discharge characteristics at room temperature and at high temperature, high ionic conductivity and excellent mechanical properties.

### BRIEF DESCRIPTION OF THE DRAWINGS

These and other features of this invention will now be described with reference to the drawing which is intended to illustrate and not to limit the invention.

FIG. 1 is schematic illustration of a vapor dispersion of a polar compound within a polymer network.

FIG. 2 is a schematic illustration of a liquid dispersion of a polar compound within any polymer network.

FIG. 3 is a schematic illustration of a rolling operation used for forming an electrode assembly according to the principles of the present invention.

FIG. 4 is a plot of the ratio of the positive electrode layer thickness during rolling to the positive electrode layer thickness before rolling versus the ratio of the roll gap during rolling to the roll gap before rolling of the Example and Comparative Example. This is a graph showing the evaluation of the degree of thickness strain of the positive electrode layer.

FIG. 5 is a graph showing the results of charge/discharge tests of the all-solid-state battery of the Comparative Example 1 at room temperature and high temperature (60° C.).

FIG. 6 is a plot log a (ionic conductivity) versus temperature of the electrolyte layer included in Example and Comparative Example.

FIG. 7 is a graph showing the results of a room temperature charge/discharge test of the all-solid-state battery of the Example 1.

### DETAILED DESCRIPTION

Further aspects, features and advantages of this invention will become apparent from the detailed description which follows.

As used herein, the singular forms “a”, “an” and “the” are intended to include the plural forms as well, unless the context clearly indicates otherwise. Additionally, the use of “of” is intended to include “and/or”, unless the context clearly indicates otherwise.

All of the numerical values referenced herein should be interpreted as also being modified by the term “about.” As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of a composition or composite material, or other properties and characteristics. All of the values characterized by the above-described modifier “about,” are also intended to include the exact numerical values and ranges disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the endpoints of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the inclusive sense of “and/or” and not the exclusive sense of “either/or.”

Technical and scientific terms used herein have the meaning commonly understood by one of skill in the art to which the present description pertains, unless otherwise defined. Reference is made herein to various methodologies and materials known to those of skill in the art.

Unless a specific methodology is provided, the various properties and characteristics disclosed herein are measured according to conventional techniques familiar to those skilled in the art.

As used herein, the term “bond” means that a polar compound is connected to a polymer chain. For example, with respect to the form of being “bound” to the chain of a polyethylene oxide-based copolymer, the “bonding” means that a polar compound molecule, a polar compound in the gaseous state, is fixed to the polymer chain by vapor deposition. It broadly refers to a maintained for. In other words, the “bond” is not limited to a specific type of physical bond, chemical bond, etc., but is fixed by various bonds including physical bond, chemical bond, etc., or simply attached and fixed such as adsorption. Alternatively, it means that it is included in polymer a network structure formed by cross-linking of the polymer and is located adjacent to and fixed to the polymer chain or cross-linking structure.

As used herein, and unless expressly indicated to the contrary, the term “solid” should not be construed as excluding the presence of a gaseous or liquid substance incorporated within, or otherwise added to, a solid polymer electrolyte material.

As used herein, and unless expressly indicated to the contrary, the term “network structure” should be construed as encompassing two-dimensional as well as three-dimensional network structures. Further, as used herein, the term “network structure” includes a structure having a three-dimensional frame and an internal space formed by the frame, wherein the frame is a cross-link formed by the cross-linkable functional groups. For example, it may include a polymer chain including cross-linking between functional groups and/or cross-inking between cross-linkable functional groups and a cross-linking agent. The network structure can also be referred to as a cross-linked structure.

In this specification, the polar compound, or polar compound, in the electrolyte exists or is included in a “gaseous state.” This is in contrast to the case where the polar compound or solvent is injected or otherwise included in the electrolyte in a liquid state. The polar compound is deposited in a vapor state immediately after manufacturing the electrolyte or during the filling of an all-solid-state secondary battery containing the same. During the discharge process, the polar compound exists in a state distinct from a liquid electrolyte solution, however, depending on the storage or operating conditions of the solid electrolyte and/or secondary battery, the vapor-deposited polar compound may be locally or temporarily liquefied. Even in this case, the vapor deposited polar compound exhibits a higher mobility compared with a polar compound injected in the liquid state, and is in a different state from a polar compound in the liquid state. This can also be viewed as existing or included in the “gaseous state” mentioned above.

As mentioned previously herein, conventionally, a solid electrolyte was immersed or supported in a liquid electrolyte or a solvent in a liquid state, or the liquid electrolyte or solvent was directly injected into the solid electrolyte in a liquid state in order to improve the ionic conductivity of the solid electrolyte. In this way, when a liquid electrolyte or solvent is directly added to a solid electrolyte, the ionic conductivity of the solid electrolyte is improved. This was due to the effect of increasing the ionic conductivity of the solid electrolyte based on the high ionic conductivity of the liquid itself. However, the degree of improvement was insufficient, requiring injection of a significant amount of liquid electrolyte. In other words, since the conduction of lithium ions is achieved by the liquid electrolyte added to the solid electrolyte, rather than improving the physical properties of the solid electrolyte itself. In addition, when a liquid electrolyte or solvent is directly added or injected into a solid electrolyte in a liquid state, the polymer chain may be damaged or bonds within the polymer may be broken due to undesired side reactions between the polymer and the liquid phase, causing damage to the solid electrolyte. There was a problem that the structure collapsed, or the ionic conductivity decreased due to this damage.

Accordingly, the present invention includes deposition of a polar compound in a gaseous state derived from a polar compound to a solid electrolyte. The present invention optionally further includes deposition of a polar compound in a gaseous state to a solid electrolyte containing a ceramic compound. The solid electrolyte is optionally in the form of a polymer cross-linked with a polyethylene oxide (PEO)-based copolymer modified with a cross-linkable functional group. According to certain aspects solid electrolytes of the present invention may optionally include a polymer containing a PEO-based copolymer containing a cross-linkable functional group, a ceramic compound, a polar compound, wherein at least some of the cross-linkable functional groups form cross-links with each other so that the polymer forms a network structure, and the polar compound is contained in the network structure in a gaseous state. Alternatively, the polar compound may represent a structure bound to the polymer chain.

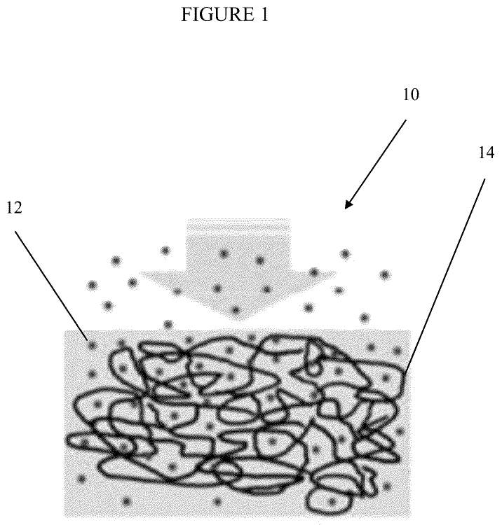

These solid electrolytes convert polar compounds derived from trace amounts of polar compounds into gases. It was confirmed that improved ionic conductivity of solid electrolytes formed according to the present invention was observed. Without being bound to any specific theory, and with reference to FIG. 1, it is believed that the gaseous deposition 10 of the polar compounds in a gaseous state 12 into the polymer network 14 results in a uniform dispersion of the polar compound therein and affects the physical properties such as crystallinity of the PEO-based copolymer, and increasing the chain mobility of the polymer chain. This increased mobility appears to improve the conductivity of lithium ions contained in the polymer electrolyte.

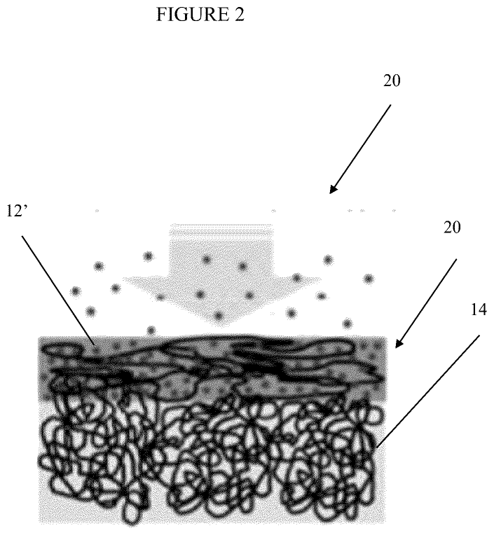

By contrast, with reference to FIG. 2, the liquid deposition 20 of the polar compounds in a liquid state 12′ into the polymer network 14 results in the liquid molecules rapidly diffusing into the solid electrolyte, causing rapid relaxation of the polymer chain, promoting gelation on the surface 22 and thereby deteriorating the mechanical properties. Deterioration may occur, problems such as leakage of liquid electrolyte may not be completely solved.

Furthermore, the solid electrolyte may exhibit superior ionic conductivity due to the ceramic compound being uniformly dispersed within the network structure.

According to certain aspects of the present invention, a solid electrolyte does not substantially contain a liquid polar solvent or electrolyte solution, and exhibits improved ionic conductivity which can greatly contribute to the development of all-solid-state batteries with excellent physical properties.

Hereinafter, an electrolyte, a solid electrolyte and a solid composite electrolyte formed according to embodiments of the present invention will be described in detail.

According to certain aspects, a solid electrolyte of one embodiment of the present invention includes: a cross-linkable functional group; polyethylene oxide (PEO)-based copolymer; ceramic compound; and a polar compound.

At least some of the cross-linkable functional groups of the copolymer can form cross-links through a cross-linking agent, so that the polymer forms a network structure. The polar compound can be contained in the network structure in a gaseous state, or is bound to the polymer chain.

According to one exemplary embodiment, the polar compound in the gaseous state may be dispersed between polymer chains forming the network structure, or may be adsorbed or bound to the surface or interior of the polymer chain.

The electrolyte optionally contains substantially no liquid solvent or electrolyte solution; it contains a polar compound, in small amounts, contained or bound in a gaseous state by vapor deposition, which will be described later. When observed with the naked eye or an electron microscope, it can be confirmed that liquid components are not observed on the surface of the electrolyte layer. In contrast, if a liquid polar compound is injected to the electrolyte layer the liquid polar compound can be observed. Also, as confirmed through the Examples described here, the solid electrolyte of one embodiment in which the polar compound is vapor-deposited and contained in a gaseous state exhibits significantly high ionic conductivity compared to the case where liquid polar compound or electrolyte solution is injected. Through this comparison of ionic conductivity, it was found that the solid electrolyte of the present invention, in which the polar compound is vapor-deposited and contained in a gaseous state, exhibit superior ionic conductivity as compared with an electrolyte containing a liquid injected polar compound.

The electrolyte of the present invention, according to certain embodiments, comprises a polymer formed from a copolymer containing at least one cross-linkable functional group. According to certain aspects, the cross-linkable functional group is associated with of a polyethylene oxide (PEO)-based copolymer.

The cross-linkable functional group may be directly bound to the main chain of the polymer formed from a copolymer. Alternatively, the cross-linkable functional group may be linked thereto via a linker having a 1 to 10 carbon number. According to certain embodiments, the linker is an alkylene or alkylene oxide linker.

According to the present invention, the cross-linkable functional group may be selected from the group consisting of a hydroxyl group, a carboxyl group, an isocyanate group, a nitro group, a cyano group, an amine group, an amide group, an epoxy group and an allyl group. According to certain embodiments, the cross-linkable functional group may be selected the group consisting of an epoxy group and an allyl group.

The cross-linkable functional group may include two or more types of the above-mentioned functional groups. The cross-linkable functional groups may be the same or different from each other, and preferably may be different. When the cross-linkable functional groups are different, multiple types of repeating units each containing these functional groups may be included. Also, when multiple types of cross-linkable functional groups are included, control of the mobility and ionic conductivity of the polymer chain may become easier.

The cross-linkable functional group refers to a functional group that can form cross-links with each other through a cross-linking agent, and is attached to the main chain of the polymer chain. It can optionally be combined in the form of a side chain.

According to one exemplary embodiment, the electrolyte comprises a polymer formed from a polyethylene oxide-based copolymer that contains the at least one cross-linkable functional group. According to other embodiments, the copolymer comprises repeating units of the following formulas 1 to 3:

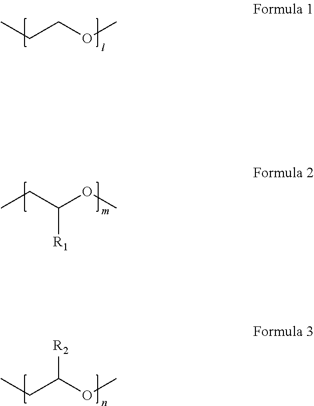

In the above formulas 1 to 3, R₁ represents —CH₂—O—(CH₂—CH₂—O)ₖ—R₃, k is 0 to 20, and R₃ represents an alkyl group having 1 to 5 carbon atoms,
R₂ represents a substituent in which one or more cross-linkable functional groups selected from the group consisting of a hydroxyl group, a carboxyl group, an isocyanate group, a nitro group, a cyano group, an amine group, an amide group, an epoxy group and an allyl group are bonded to a polymer chain via an alkylene linker or alkylene oxide linker having 0 to 10 carbon atoms (provided that an alkylene linker having 0 carbon atoms represents a single bond).

l, m, and n are the number of repetitions of the repeating unit, where 1 and n are each independently an integer from 1 to 100,000, or 50 to 80,000, or 100 to 50,000 and m is an integer from 0 to 100,000, or 50 to 80,000, or 100 to 50,000.

When l, m, and n are each too small, it is difficult to form a polymer due to the low molecular weight. When l, m, and n are each too large, the solubility decreases when preparing a polymer solution due to an increase in viscosity, and molding and mixing the solid electrolyte during manufacturing may become difficult. In particular, when the number of repeats of the repeating unit containing the cross-linkable functional group among l, m, and n is too large, the degree of cross-linking may be excessively increased and the mobility of the polymer chain may decrease, resulting in a decrease in ionic conductivity.

In this specification, “hydroxy group” refers to —OH— group.

In this specification, “carboxyl group” refers to —COOH— group.

In this specification, “isocyanate group” refers to a —N═C═O— group.

As used herein, “nitro group” refers to —NO₂— group.

In this specification, “cyano group” refers to a —CN— group.

As used herein, “amine group” may be selected from the group consisting of a monoalkylamine group; a monoarylamine group; a monoheteroarylamine group; a dialkylamine group; a diarylamine group; a diheteroarylamine group; an alkylarylamine group; an alkylheteroarylamine group; and an arylheteroarylamine group, and the carbon number thereof is not particularly limited, but is preferably 1 to 30. Specific examples of the amine group include a methylamine group, a dimethylamine group, an ethylamine group, a diethylamine group, a phenylamine group, a naphthylamine group, a biphenylamine group, a dibiphenylamine group, an anthracenyl amine group, a 9-methyl-anthracenylamine group, a diphenylamine group, a phenylnaphthylamine group, a ditolylamine group, a phenyltolylamine group, a triphenylamine group, a biphenylnaphthylamine group, a phenylbiphenyl amine group, a biphenylfluorenylamine group, a phenyltriphenylenylamine group, a biphenyltriphenylenylamine group, and the like, but are not limited thereto.

As used herein, “amide group” refers to —C(═O)NR′R″, wherein R′ and R″ may each independently be hydrogen or a C1 to C5 alkyl group, or R′ and R″ together with the N atom to which they are attached may form a heterocycle having C4 to C8 atoms in the ring structure.

As used herein, “amino group” refers to —NH₂—.

As used herein, “epoxy group” refers to a group comprised of two carbons and an oxygen forming a ring structure.

As used herein, “allyl group” refers to the —CH₂—CH═CH₂— group.

The weight average molecular weight (Mw) of the copolymers containing the formulas 1 to 3 may be 100,000 g/mol to 4,000,000 g/mol, specifically, 100,000 g/mol or more, 200,000 g/mol or more, or 300,000 g/mol or more, and 3,000,000 g/mol or less, or 2,000,000 g/mol or less. If the weight average molecular weight (Mw) is too small, the mechanical properties of the manufactured solid electrolyte may not be adequate. If the weight average molecular weight (Mw) is too large, the solubility may decrease when preparing a polymer solution due to an increase in viscosity and molding or mixing during manufacturing a solid electrolyte may become difficult. Additionally, the ionic conductivity of the solid electrolyte may decrease due to increased crystallinity and decreased chain mobility inside the electrolyte.

Additionally, the copolymer may be a random copolymer or a block copolymer.

According to one specific embodiment, the cross-linkable functional group of R₂ can form a polymer having a network structure formed by cross-linking. By forming a network structure, the mechanical properties of the solid electrolyte can be improved. In one embodiment, a solid electrolyte with improved ionic conductivity can be provided by including or combining the polar compound in the gaseous state within this network structure.

In addition, the PEO-based copolymer may include two or more repeating units of Formula 3 in which R₂ is a different cross-linkable functional group. One or more types of repeating units of Formula 2 may also be included.

According to certain aspects, the polar compound may be contained or bound to the surface or interior of the polymer chain in a gaseous state. Specifically, the polar compound in the gaseous state may be diffused or dispersed between the polymer chains forming a network structure, or may be adsorbed or bound to the surface or interior of the polymer chains. Thus, the polar compound can improve the ionic conductivity of the final manufactured electrolyte.

Specifically, a polar compound bound to the polymer chain or included between the polymer chains can act as a plasticizer and plasticize the polymer. The plasticized polymer may have an increased amorphous region inside, thereby improving the mobility of the polymer chain. As the mobility of the polymer chain improves, the ion hopping effect inside the polymer increases, and the ionic conductivity of the solid electrolyte can be improved.

In addition, the polar compound can act as an intermediate. Since the affinity between lithium ions and polar compounds is stronger than the affinity between lithium ions and the ether oxygen of PEO-based copolymers, the transfer of lithium ions within the polymer to which the polar compounds are adsorbed is more likely. In other words, as the polar compound is introduced into the polymer, the cation solvation effect of lithium ions is increased, so ion mobility is improved, and thus the ionic conductivity of the solid electrolyte can be improved.

The polar compound may include one or more types selected from the group consisting of carbonate-based compounds and sulfonyl-based compounds.

According to certain embodiments, the polar compounds may include ethyl methyl carbonate (EMC), dimethyl carbonate (DMC), diethyl carbonate (DEC), ethylene carbonate (EC), propylene carbonate (PC), vinylene carbonate (VC), and sulfolane, or a combination thereof.

The content of the polar compound may include 0.1% by weight or more and less than 10% by weight, based on the total weight of the electrolyte. For example, the content of the polar compound may be 0.1 wt % or more, 1 wt % or more, 2 wt % or more, or 5 wt % or less, 6 wt % or less, 7 wt % or less, 8 wt % or less, or 9 wt % or less, or may be less than 10% by weight. When the content of the polar compound is less than 0.1% by weight, it is difficult to cause a change in the chain conformation inside the polymer, so the ionic conductivity of the solid electrolyte is not improved. When the content of the polar compound is 10% by weight or more, the content in the polar compound is high, so the polymer begins to take on the properties of a semi-solid electrolyte. Additionally, the mechanical strength of the electrolyte may decrease due to gelation of the polymer.

The electrolyte may contain a crosslinking agent. At least some of the cross-linkable functional groups form cross-links with each other through the cross-linking agent, thus the above-described network structure can be formed. The crosslinks may be hydrogen bonds, bonds formed by Lewis acid-base interactions, ionic bonds, coordination bonds, or radical polymerization bonds.

There is no particular limitation as to the type of cross-linking agent utilized, so long as forms the desired cross links. The crosslinking agent can be a multifunctional compound and includes a plurality of curable functional groups capable of forming crosslinks with the cross-linkable functional group. For example, it may be a compound having two or more functions.

The crosslinking agent can be a (meth)acrylic functional group, alkoxy functional group, peroxide type functional group, vinyl type functional group, hydroxyl group, or an epoxy-based system. One or more types of cross-linking agent may be utilized. According to certain option embodiments, the polyfunctional compounds having a plurality of curable functional groups can be selected from the group consisting of functional groups and allyl groups.

In a more specific example, the crosslinking agent is trimethylolpropane trimethacrylate, polyethylene glycol diacrylate (poly(ethylene glycol) diacrylate), polyethylene glycol dimethacrylate (poly(ethylene glycol) dimethacrylate), ethylene glycol dimethyl acrylate (ethylene glycol dimethylacrylate) (“EGDMA”), 1,3-diisopropenylbenzene (DIP), 1,4-diacryloyl piperazine (1,4-diacryloyl piperazine), 2-(diethylamino)ethyl methacrylate (2,6-bisacryloylamidopyridine, 2,6-bisacryloylamidopyridine, 3-(acryloxy)-2-hydroxypropyl methacrylate, 3,5-bis(acryloylamido)benzoic acid, 3-aminopropyltriethoxysilane, 3-isocyanatopropyltriethoxysilane, 3-methylacryloxypropyl trimethoxysilane, bis-(1-(tert-butyl peroxy)-1-methylethyl)-benzene, dicumyl peroxide, dimethacrylate, divinylbenzene, ethylene glycol, ethylene glycol maleic rosinate acrylate, glycidilmethacrylate, hydroxy quinoline (hydroxyquinoline), iphenyldiethoxysilane, maleic rosin glycol acrylate (maleic rosin glycol acrylate), methylene bisacrylamide(methylene bisacrylamide), N,N′1,4-phenylenediacrylamine (N,N′-1,4-phenylene diacrylamine), N,O-bisacryloyl phenylalaninol (N,O-bis-acryloyl-phenylalaninol), N,O-bismethacryloyl ethanolamine (N,O-bis-methacryloyl ethanolamine), pentaerythritol triacrylate, phenyltrimethoxy silane, tetramethoxysilane, tetramethylene, tetraethoxysilane, triallyl isocyanurate, or combinations thereof.

In addition, the cross-linking agent may be included in any suitable amount. According to certain alternative embodiments, the amount cross-linking agent is included in an amount take such that a ratio of the weight of the cross-linking agent to the weight of the PEO-based copolymer containing to the cross-linkable functional group is expressed as:

$${f}_{XL} = \frac{{W}_{XL}}{{W}_{P}} ,$$

wherein W_{XL} is the weight of the cross-linking agent, W_{P} is the weight of the polyethylene oxide-based copolymer, and f_{XL} is 0.07 to 0.19, or 0.07 to 0.18, or 0.08 to 0.15, or 0.08 to 0.13. If the weight ratio of the cross-linking agent is too small, the formation of a network structure is not properly achieved, making it difficult to apply the polar compound through vapor deposition. As a result, the ionic conductivity of the solid electrolyte may be greatly reduced. On the other hand, when the weight ratio of the crosslinking agent becomes too large, excessive cross-linking of network structure may result in a decrease in the mobility of the polymer chains, thereby lowering ionic conductivity.

According to certain aspects of the invention, the solid electrolyte may further include lithium salt. The lithium salt is contained in a dissociated ion state in the internal space between polymer chains, thereby improving the ionic conductivity of the electrolyte. At least a portion of the cations and/or anions dissociated from the lithium salt remain bound to the polymer chain. Ion mobility can be shown when charging/discharging a battery containing the electrolyte.

The lithium salt can be (CF₃SO₂)₂NLi (lithium bis(trifluoromethanesulphonyl)imide, LiTFSI), (FSO₂)₂NLi(lithium bis(fluorosulfonyl)imide, LiFSI), LiNO₃, LiOH, LiCl, LiBr, LiI, LiClO₄, LiBF₄, LiB₁₀Cl₁₀, LiPF₆, LiCF₃SO₃, LiCF₃CO₂, LiAsF6, LiSbF₆, LiAlCl₄, CH₃SO₃Li, CF₃SO₃Li, LiSCN, LiC(CF₃SO₂)₃, lithium chloroborane, lithium lower aliphatic carboxylate and lithium tetraphenyl borate. According to alternative embodiments, the lithium salt may include lithium borate.

Further, the lithium salt may be included in an amount of 25 to 45 parts by weight, based on 100 parts by weight of the PEO-based copolymer containing the cross-linkable functional group. Specifically, it may be included in an amount of 25 parts by weight or more, 30 parts by weight or more, or 35 parts by weight or more, or 40 parts by weight or less, or 45 parts by weight or less. If the content of the lithium salt is less than 25 parts by weight, the ionic conductivity of the electrolyte may decrease, and if the content of the lithium salt exceeds 45 parts by weight, the mechanical strength may decrease.

The above-described electrolyte may further include a ceramic compound. The ceramic compound has a lithium ion transfer ability to improve the conductivity of lithium ions, and preferably contains lithium atoms but does not store lithium, and has the function of transporting lithium ions, and can improve the ionic conductivity of the electrolyte.

In addition, the ceramic compound may be included in a uniformly dispersed state in the internal space of crosslinked polymer chains, for example, within the network structure. The ceramic compound is added together in the cross-linking process, and can be uniformly dispersed without aggregation in the internal space of the polymer chains formed by crosslinking. Such ceramic compounds can be advantageous in improving the mechanical strength and ionic conductivity of the composite electrolyte due to its uniformly dispersed form.

Further, the ceramic compound may be in the form of particles. Due to the morphological characteristics of particles, they can be contained in a more uniformly dispersed state within the composite electrolyte. The particles of the ceramic compound may be spherical, and its diameter may be 100 nm to 1000 nm. If the diameter is less than 100 nm, the effect of non-crystallization due to the decrease in crystallinity of the polymer may be slight, and if the diameter is more than 1000 nm, dispersibility may decrease due to an increase of aggregation between particles, which may make it difficult to disperse uniformly.

The ceramic compound may be an oxide-based or phosphate-based compound, for example, an oxide-based ceramic compound can be in the form of lithium metal oxide or lithium metal phosphate. More specifically, the ceramic compound may be at least one selected from the group consisting of garnet-type lithium-lanthanum-zirconium oxide(LLZO, Li₇La₃Zr₂O₁₂)-based compound, perovskite-type lithium-lanthanum-titanium oxide(LLTO, Li₃ₓLa_{2/3-x}TiO₃)-based compound, phosphate-based NASICON type lithium-aluminum-titanium phosphate(LATP, Li₁₊ₓAlₓTi₂₋ₓ(PO₄)₃)-based compound, lithium-aluminum-germanium phosphate(LAGP, Li_{1.5}Al_{0.5}Ge_{1.5}(PO₄)₃)-based compound, lithium-silicon-titanium phosphate(LSTP, LiSiO₂TiO₂(PO₄)₃)-based compound, and lithium-lanthanum-zirconium-titanium oxide (LLZTO)-based compound. More preferably, at least one oxide-based ceramic compound selected from the group consisting of lithium-lanthanum-zirconium oxide(LLZO), lithium-silicon-titanium phosphate(LSTP), lithium-lanthanum-titanium oxide(LLTO), lithium-aluminum-titanium phosphate(LATP), lithium-aluminum-germanium phosphate(LAGP), and lithium-lanthanum-zirconium-titanium oxide(LLZTO) may be used. One or more types of oxide-based ceramic compounds selected from can be used.

The oxide-based or phosphate-based ceramic compound generally have an ionic conductivity value of up to 10⁻⁴˜10⁻³ S/cm at room temperature, and has the advantage of being stable in a high voltage region, being stable in air, and thus being easy to synthesize and handle.

Therefore, the above-mentioned electrolyte may comprise a composite electrolyte mixed with a ceramic compound to compensate for the drawbacks associated with a polymer-based solid electrolyte.

Further, the ceramic compound does not easily cause combustion or ignition phenomenon even under high temperature conditions of 400° C. or more, and thus has increased high-temperature stability. Therefore, when the composite electrolyte contains a ceramic compound, not only the mechanical strength but also the high-temperature stability and ionic conductivity of the composite electrolyte can be improved.

The ceramic compound may be included in an amount of 10 to 100 parts by weight, based on 100 parts by weight of the copolymer. All alternatively, the ceramic compound may be included in 10 to 60 parts by weight, based on 100 parts by weight of the copolymer.

If the ceramic compound is included in an amount below the above-mentioned range, the effect of lowering the crystallinity of the polymer and making it amorphous due to the ceramic compound is reduced, so that the effect of increasing the ionic conductivity of the solid electrolyte is not significant, and the mechanical properties are also degraded.

If the ceramic compound is included in an amount that exceeds the above-mentioned range, the ceramic compound is not uniformly dispersed within the polymer, causing the ceramic compound particles to clump together and aggregate, resulting in the production of a solid electrolyte with reduced ionic conductivity.

The above-described electrolyte can exhibit excellent ionic conductivity. For example, ionic conductivity measured at room temperature of about 25° C. is 0.95 mS/cm or more, or more than 0.95 mS/cm. Alternatively, it may exhibit excellent ionic conductivity of 1.0 mS/cm to 3.0 mS/cm.

This ionic conductivity can be measured using an electrochemical impedance spectrometer at a constant temperature. From the measured resistance (Q) of the solid electrolyte. It can also be calculated according to Equation 1 below:

$${σ}_{i} = \frac{L}{RA} \qquad [ Equation 1 ]$$

In Equation 1, σᵢ is the ionic conductivity of the solid electrolyte (S/cm), R is the resistance (Ω) of the solid electrolyte measured with the electrochemical impedance spectrometer, and L is the thickness of the solid electrolyte (in μm), and A means the area of the solid electrolyte (in cm²).

The electrolyte optionally has an activation energy deviation (ΔEₐ) by temperature defined by Equation 1 below of 0.03 eV or less:

$$Δ {E}_{a} = {{E}_{a}}^{LT} - {{E}_{a}}^{HT} , \qquad Equation 1$$

wherein in Equation 1, Eₐ^{LT} is the activation energy of the electrolyte layer at −40° C. to 10° C., Eₐ^{HT} is the activation energy of the electrolyte layer from 10° C. to 80° C., ΔEa represents the activation energy deviation by temperature, which is defined as the difference between the two activation energies. Alternatively, the activation energy deviation (ΔEₐ) may be 0.005 to 0.025 eV.

At this time, the activation energy deviation can be calculated from the ionic conductivity of the electrolyte measured by absolute temperature. More specifically, based on the measurement result of ionic conductivity (σi) by temperature, the activation energy Ea corresponding to the slope can be derived by fitting the relationship between log(σi) and 1000/T (T is the absolute temperature at which the corresponding ion conductivity was measured) with the Arrhenius formula of Eq. 3 below, from which the Eₐ^{LT}, Eₐ^{HT} and ΔEₐ of the Eq. 1 can be calculated respectively.

$${σ}_{i} = {σ}_{i , 0} exp [ - \frac{{E}_{a}}{RT} ] \qquad [ Equation 3 ]$$

In the equation, σi, 0 represents the maximum ionic conductivity of the electrolyte layer, σi represents the ionic conductivity of the electrolyte layer measured at absolute temperature T, Ea represents the activation energy of the electrolyte layer at absolute temperature T, and R represents the gas constant.

From this low activation energy deviation, it can be seen that the above-described electrolyte exhibits excellent ionic conductivity and electrochemical properties without significant deviations despite temperature variations.

Further, the electrolyte layer optionally has an activation energy deviation (ΔEₐ) by temperature defined by Equation 1 0.005 to 0.025 eV.

Hereinafter, exemplary methods of manufacturing the electrolyte of the present invention will be described.

According to one such embodiment, the method generally comprises the steps of: (S1) preparing a mixture comprising a polyethylene oxide-based copolymer containing a cross-linkable functional group, a cross-linking agent, and a ceramic compound, wherein the mixture optionally comprises a weight ratio of cross-linking agent to polyethylene oxide-based copolymer expressed as:

$${f}_{XL} = \frac{{W}_{XL}}{{W}_{P}} ,$$

wherein W_{XL} is the weight of the cross-linking agent, W_{P} is the weight of the polyethylene oxide-based copolymer, and ƒ_{XL} is 0.07 to 0.19; (S2) polymerizing the mixture, wherein the polymerization comprises at least a portion of the cross-linkable functional groups forming cross-links with the cross-linking agent, and the resulting polymer is in the form of a network structure; (S3) vapor-depositing a polar solvent onto the polymer prepared in steps (S1)-(S2).

In a step (S1)-(S2), a cross-linking reaction is performed on the PEO-based copolymer contained in this mixture in the presence of the ratio of cross-linking agent, both previously described herein. Thus, a polymer forming the above-described network structure can be formed. Optionally, in (S1) the PEO-based copolymer and the previously described ceramic compound are mixed, and then the cross-linking reaction is performed on the mixture. The crosslinking reaction in step (S2) may proceed in the presence of the crosslinking agent and an initiator of the type previously disclosed herein.

The types and amounts of all the constituent components utilized according to these methods of the present invention are the same types and amounts described elsewhere herein.

The cross-linking reaction may be performed in the process of forming a coating film by applying a solution or slurry containing the PEO-based copolymer and a ceramic compound, and the other above-described constituents, on a substrate and then drying the deposited solution.

Specifically, the mixed solution or slurry may be prepared by mixing the PEO-based copolymer and the ceramic compound in a solvent, and may additionally be prepared by mixing a crosslinking agent, an initiator, and/or a lithium salt. In addition, the above PEO-based copolymer and crosslinking agent, initiator and/or a solution containing a lithium salt may be prepared first, and then a mixed solution or suspension may be prepared by adding a ceramic compound.

The solvent is not particularly limited as long as it is a solvent that can be mixed and dissolved with the PEO-based copolymer, ceramic compound, the crosslinking agent, the initiator and/or the lithium salt, and can be easily removed by a drying process. For example, the solvent may be acetonitrile, methanol, ethanol, tetrahydrofuran, water, isopropyl alcohol, dimethyl sulfoxide(DMSO), N-methyl-2-pyrrolidone(NMP), N,N-dimethyl formamide(DMF) or the like. Such a solvent is a solvent that serves as a reaction medium for forming a crosslinking bond, and is distinguished from polar solvents contained in liquid electrolytes, and the like, and is completely removed by drying or the like after crosslinking.

The concentration of the polymer solution can be appropriately adjusted in consideration of the extent to which the molding process for preparing the polymer solid electrolyte can proceed smoothly. Specifically, the concentration of the polymer solution may mean the concentration (w/w %) of the polymer in the polymer solution. The concentration of the polymer may be the concentration of the PEO-based copolymer. For example, the concentration of the polymer solution may be 5% by weight to 20% by weight, and specifically, it may be 5% by weight or more, 7% by weight or more, or 9% by weight or more, and 13% by weight or less, 17% by weight or less, or 20% by weight or less. If the concentration of the polymer solution is less than 5% by weight, the concentration may be too diluted, and the mechanical strength of the polymer solid electrolyte may decrease, or it may flow down when coated onto a substrate. If the concentration of the polymer solution is more than 20% by weight, it will be difficult to dissolve the lithium salt at the desired concentration in the polymer solution, the viscosity will be high, and the solubility will be low, which makes it difficult to coat the lithium salt in the form of a uniform thin film.

The substrate is not particularly limited as long as it can function as a support for the coating film. For example, the substrate may SUS (stainless use steel), polyethylene terephthalate film, polytetrafluoroethylene film, polyethylene film, polypropylene film, polybutene film, polybutadiene film, vinyl chloride copolymer film, polyurethane film, ethylene-vinylacetate film, ethylene-propylene copolymer film, ethylene-ethyl acrylate copolymer film, ethylene-methyl acrylate copolymer film or polyimide film.

Further, the coating method is not particularly limited as long as it can form a coating film by coating the polymer solution onto the substrate. For example, the coating method may be bar coating, roll coating, spin coating, slit coating, die coating, blade coating, comma coating, slot die coating, lip coating, spray coating or solution casting.

The coating film formed on the substrate by the coating method can be molded into a polymer from which the residual solvent is completely removed through a drying process. The drying can be performed separately by a primary drying process and a secondary drying process in order to prevent shrinkage of the polymer due to rapid evaporation of the solvent. The first drying process can remove part of the solvent through room temperature drying, and the secondary drying process can completely remove the solvent through vacuum high temperature drying. The high temperature drying may be performed at a temperature of 80° C. to 130° C. If the high-temperature drying temperature is less than 80° C., the residual solvent cannot be completely removed, and if the high-temperature drying temperature is more than 130° C., the polymer shrinks which makes it difficult to form uniform electrolyte membranes

Additionally, the cross-linking agent may form a bond with the cross-linkable functional group. Descriptions of the type of cross-linking agent, the content (weight ratio) of the cross-linking agent, and the type of bond between the cross-linking functional group are as described elsewhere herein.

In one embodiment of the disclosure, the initiator may induce a radical polymerization reaction between the cross-linkable functional groups to form a crosslinking bond between the cross-linkable functional groups. The functional group that enables the radical polymerization reaction may be a functional group containing vinyl at the end, for example, an allyl group.

The initiator is not particularly limited as long as it is an initiator that can induce a radical polymerization reaction between the cross-linkable functional groups. For example, the initiator may include at least one selected from the group consisting of benzoyl peroxide, azobisisobutyronitrile, lauroyl peroxide, cumene hydroperoxide, diisopropylphenyl-hydroperoxide, tert-butyl hydroperoxide, p-methane hydroperoxide and 2,2′-azobis(2-methylpropionitrile). The initiator may include a combination of initiators selected from the above-mentioned group.

The initiator may be used in an amount of 0.5 to 2 parts by weight, based on 100 parts by weight of the PEO-based copolymer containing a cross-linkable functional group. When the initiator is used within the above range, it can make it possible to induce a radical polymerization reaction between cross-linkable functional groups and efficiently form a crosslinking bond.

In step (S3), a polar compound may be vapor-deposited onto the polymer prepared in steps (S1)-(S2) to prepare a polymer solid electrolyte in which polar compound gas molecules are bound to the polymer chain, or a polar compound in a gaseous state is included in the internal space of the polymer chain, for example, in a network structure (e.g., three-dimensional network structure). The polar compound, and the amount utilized, are as described elsewhere herein.

Vapor deposition may be performed by contacting the polymer with vapor of the polar compound generated at room temperature or by heating the polar compound and penetrating into the polymer. Vapor disposition at room temperature or vapor deposition through heating results in the polar compound in the gaseous state being uniformly diffused on the surface of and/or inside the polymer, so that the polar compound gas molecules are bound to the polymer chain, or a polar compound in a gaseous state is included in the internal space of the polymer chain, for example, in a three-dimensional network structure.

With regard to vapor deposition every temperature, when the polar solvent is left at room temperature, a small amount of the polar solvent with a low boiling point is slowly vaporized at room temperature and penetrates into the polymer, effectively inducing a change in the conformation of the cross-linked polymer chain within the polymer.

Additionally, when heating a polar solvent during vapor deposition, the vapor deposition rate can be improved. The heating temperature is not particularly limited as long as it is a temperature at which the polar solvent can change phase into vapor, and may be, for example, 30° C. to 80° C. Normally, PEO melts at 60° C., but the PEO-based copolymers modified with the cross-linking functional group(s) of the present invention have improved heat resistance, and can withstand temperatures up to 80° C., allowing the vapor deposition rate to be faster. Additionally, the heating method is not limited to any method that can supply energy to generate steam. For example, a direct heating method using a burner or stove, or an indirect heating method using a heater or steam pipe, etc. can be used, but the method is not limited to these examples.

When heating at an excessively high temperature, the polar solvent above the boiling point, the solvent may boil, the structure of the solvent may change, or the polymer may be deformed. This is disadvantageous in that it is difficult to control the evaporation rate of the polar solvent during vapor deposition, so vapor deposition of a small amount of polar solvent is difficult to achieve. Thus, it is desirable to carry out vapor deposition at a heating temperature in the appropriate range as specified above.

A further aspect of the present invention also relates to an electrode assembly and an all-solid-state battery including the electrolyte described herein, as well as a positive electrode comprising a positive electrode active material and a binder comprising the polymer network including the polyethylene oxide-based copolymer having the cross-linkable functional groups.

Specifically, the electrolyte is a PEO-based copolymer containing a cross-linkable functional group. It includes a polymer cross-linked through a cross-linking agent and a polar compound in the gaseous state, and the polar compound in the gaseous state is included or combined. The electrolyte optionally includes a ceramic compound that is uniformly dispersed therein, thus exhibiting improved ionic conductivity. This electrolyte, it can be suitable for use in an all-solid-state battery.

The positive electrode included in the all-solid-state battery may include a positive electrode active material layer, and the positive active material layer may be formed on one side of the positive electrode current collector. The positive electrode active material layer may include a positive electrode active material, a binder, and optionally a conductive material. According to the principles of the present invention, the binder comprises the polymer network including the polyethylene oxide-based copolymer having the cross-linkable functional groups, as previously described herein.

The positive electrode active material is not particularly limited as long as it is a material capable of reversibly absorbing and desorbing lithium ions, and examples thereof may be a layered compound, such as lithium cobalt oxide, lithium nickel oxide, Li[NiₓCo_{y}Mn_{z}Mᵥ]O₂ (where M is any one selected from the group consisting of Al, Ga, and In, or two or more elements thereof; and 0.3≤x<1.0, 0≤y, z≤0.5, 0≤v≤0.1, and x+y+z+v=1), Li(LiₐM_{b-a-b′}M′b_{′})O_{2-c}A_{c} (where 0≤a≤0.2, 0.6≤b≤1, 0≤b′≤0.2, and 0≤c≤0.2; M includes Mn and at least one selected from the group consisting of Ni, Co, Fe, Cr, V, Cu, Zn, and Ti; M′ is at least one selected from the group consisting of Al, Mg, and B; and A is at least one selected from the group consisting of P, F, S, and N), or a compound substituted with at least one transition metal; lithium manganese oxides such as the chemical formula Li_{1+y}Mn_{2-y}O₄ (where y ranges from 0 to 0.33), LiMnO₃, LiMn₂O₃, and LiMnO₂; lithium copper oxide (Li₂CuO₂); vanadium oxides such as LiV₃O₈, LiFe₃O₄, V₂O₅, and Cu₂V₂O₇; Ni-site type lithium nickel oxide expressed by the chemical formula LiNi_{1-y}M_{y}O₂ (where M is Co, Mn, Al, Cu, Fe, Mg, B, or Ga, and y ranges from 0.01 to 0.3); lithium manganese complex oxide expressed by the chemical formula LiMn_{2-y}M_{y}O₂ (where M is Co, Ni, Fe, Cr, Zn, or Ta, and y ranges from 0.01 to 0.1) or Li₂Mn₃MO₈ (where M is Fe, Co, Ni, Cu, or Zn); LiMn₂O₄ having a part of Li being substituted with alkaline earth metal ions; a disulfide compound; and a complex oxide formed of Fe₂(MoO₄)₃, but are not limited thereto.

Further, the positive electrode active material may be included in an amount of 40 to 80% by weight, based on the total weight of the positive electrode active material layer. Specifically, the content of the positive electrode active material may be 40% by weight or more or 50% by weight or more, and 70% by weight or less or 80% by weight or less. If the content of the positive electrode active material is less than 40% by weight, the connectivity and electrical properties between positive electrode active materials may be insufficient, and if the content of the positive electrode active material is more than 80% by weight, the mass transfer resistance may increase.

In addition, the binder may include the above-described cross-linked PEO copolymer as a component that assists in the bonding of the anode active material and the conductive material and the bonding to the current collector. However, in addition to these copolymers, it is possible to include more common binders.

Examples of these additional binders are particularly but are not limited to, e.g., styrene-butadiene rubber, acrylene-butadiene rubber, acrylonitrile-butadiene rubber, nitrile butadiene rubber, acrylonitrile-styrene-butadiene copolymer, acrylic rubber, butyl rubber, fluorine rubber, polytetrafluoroethylene, polyethylene, polypropylene, ethylene/propylene copolymer, polybutadiene, polyethylene oxide, chlorosulfonated polyethylene, polyvinylpyrrolidone, polyvinylpyridine, polyvinyl alcohol, polyvinyl acetate, polyethylene pichlorohydrin, polyphosphazene, polyacrylonitrile, polystyrene, latex, acrylic resin, It may contain one or more species selected from a group of phenolic resins, epoxy resins, carboxymethylcellulose, hydroxypropyl cellulose, cellulose acetate, cellulose acetate butyrate, cellulose acetate propionate, cyanoethylcellulose, cyanoethyl sucrose, polyester, polyamide, polyether, polyimide, polycarboxylates, polycarboxylic acid, polyacrylic acid, polyacrylates, lithium polyacrylates, polymethacrylic acid, polymethacrylate, polyacrylamide, polyurethane, polyvinylidene fluoride, and poly(binilidene fluoride)-hexafluoropropene.

However, in a more appropriate example, the binder may include as a principal component a PEO copolymer having a cross-linked functional group homogeneous or identical to that contained in the electrolyte. In this way, as the solid electrolyte layer and homogeneous binder are included in the anode active material layer, the solid cell can exhibit excellent mechanical properties, along with excellent charge, discharge properties and ionic conductivity. In a more specific example, a PEO copolymer having a cross-linked functional group may be included in a proportion of more than 60% by weight, or more than 80% by weight, or at a rate of 90 to 100% by weight of the total binder.

The binder may be included in an amount of 1% by weight to 30% by weight, based on the total weight of the positive electrode active material layer. Specifically, the content of the binder may be 1% by weight or more or 3% by weight or more, and 15% by weight or less or 30% by weight or less. If the content of the binder is less than 1% by weight, the adhesion between the positive electrode active material and the positive electrode current collector may decrease, and if the content of the binder is more than 30% by weight, the adhesion is improved, but the content of the positive electrode active material is reduced accordingly, which may lower battery capacity.

The conductive material is not particularly limited as long as it does not cause side reactions in the internal environment of the battery and does not cause chemical changes in the battery but has excellent electrical conductivity. The conductive material may typically be graphite or electrically conductive carbon, and may be, for example, but is not limited to, one selected from the group consisting of graphite such as natural graphite or artificial graphite; carbon black such as carbon black, acetylene black, Ketjen black, Denka black, thermal black, channel black, furnace black, lamp black, and summer black; carbon-based materials whose crystal structure is graphene or graphite; electrically conductive fibers such as carbon fibers and metal fibers; carbon fluoride; metal powders such as aluminum and nickel powder; electrically conductive whiskers such as zinc oxide and potassium titanate; electrically conductive oxides such as titanium oxide; electrically conductive polymers such as polyphenylene derivatives; and a mixture of two or more thereof.

The conductive material may typically be included in an amount of 0.5% to 30% by weight, based on the total weight of the positive electrode active material layer. Specifically, the content of the conductive material may be 0.5% by weight or more or 1% by weight or more, and 20% by weight or less, or 30% by weight or less. If the content of the conductive material is too low, that is, less than 0.5% by weight, it is difficult to obtain an effect on the improvement of the electrical conductivity, or the electrochemical characteristics of the battery may be deteriorated. If the content of the conductive material too high, that is, more than 30% by weight, the amount of positive electrode active material is relatively small and thus capacity and energy density may be lowered. The method of incorporating the conductive material into the positive electrode is not particularly limited, and conventional methods known in the related art such as coating on the positive electrode active material can be used.

In addition, the positive electrode current collector supports the positive electrode active material layer and serves to transfer electrons between the external conductor and the positive electrode active material layer.

According to further optional embodiments, the positive electrode may further comprise a lithium salt of the same type and in the same, or similar, amount as previously disclosed herein in connection with the discussion of the electrolyte. Accordingly, the lithium salt can be included in an amount of 25 to 45 parts by weight, based on 100 parts by weight of the polyethylene oxide-based copolymer containing the cross-linkable functional groups.

The positive electrode current collector is not particularly limited so long as it does not cause chemical changes in the all-solid-state battery and has conductivity. For example, the positive electrode current collector may be made of copper, stainless steel, aluminum, nickel, titanium, palladium, fired carbon, copper or stainless steel that is surface-treated with one of carbon, nickel, titanium, silver, or the like, an aluminum-cadmium alloy, or the like.

The positive electrode current collector may have a fine protrusion and depression structure layer or may adopt a three-dimensional porous structure in order to improve bonding strength with the positive electrode active material layer. Thereby, the positive electrode current collector may be used in any of various forms including a film, a sheet, a foil, a mesh, a net, a porous body, a foaming body, and a non-woven fabric structure.

The positive electrode as described above can be prepared according to conventional methods. Specifically, the positive electrode can be prepared by a process in which a composition for forming a positive electrode active material layer, which is prepared by mixing a positive electrode active material, a conductive material, and a binder in an organic solvent, is coated and dried on a positive electrode current collector, and optionally, compression molding is performed on the current collector to improve the electrode density. At this time, as the organic solvent, a solvent that can uniformly disperse the positive electrode active material, binder, and conductive material, and that evaporates easily, is preferably used. Specifically, acetonitrile, methanol, ethanol, tetrahydrofuran, water, isopropyl alcohol, dimethyl sulfoxide(DMSO), N-methyl-2-pyrrolidone(NMP), and the like can be mentioned.

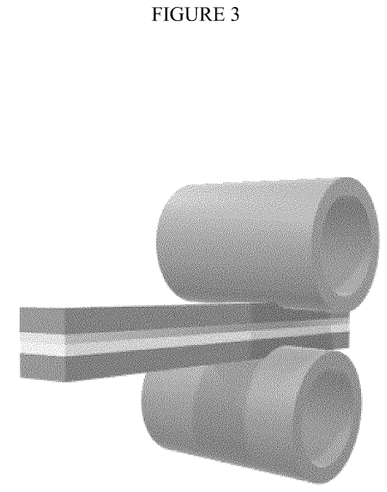

The positive electrode optionally satisfies the thickness strain relationship defined by Equation 2 below when rolled on both sides using a roll, as illustrated in FIG. 3:

$$\frac{d}{{d}_{0}} = C {( \frac{{δ}_{0}}{δ} )}^{- n} \qquad Equation 2$$

wherein in Equation 2 above, δ₀ and d₀ indicates the initial roll gap and initial thickness of the positive electrode before rolling, δ and d represents the roll gap and the thickness of the positive electrode during rolling, C is a constant determined by regression analysis.

The negative electrode contained in the all-solid-state battery includes a negative electrode active material layer, and the negative electrode active material layer may be formed on one surface of the negative electrode current collector.

The negative electrode active material may include a material capable of reversible intercalation and deintercalation of lithium (L⁺), a material that can react with lithium ions to reversibly form a lithium-containing compound, lithium metal or lithium alloy.

The material capable of reversibly inserting or de-inserting lithium ions (Li⁺) may be, for example, crystalline carbon, amorphous carbon, or a mixture thereof. The material that can react with the lithium ion (Li⁺) to reversibly form a lithium-containing compound may be, for example, tin oxide, titanium nitrate, or silicon. The lithium alloy includes, for example, lithium (Li), sodium (Na), potassium (K), rubidium (Rb), cesium (Cs), francium (Fr), beryllium (Be), magnesium (Mg), and calcium. It may be an alloy of a metal selected from the group consisting of (Ca), strontium (Sr), barium (Ba), radium (Ra), aluminum (Al), and tin (Sn).

Preferably, the negative electrode active material may be lithium metal, and specifically, may be in the form of a lithium metal thin film or lithium metal powder.

The negative electrode active material may be included in an amount of 40 to 80% by weight, based on the total weight of the negative electrode active material layer. Specifically, the content of the negative electrode active material may be 40% by weight or more or 50% by weight or more, and 70% by weight or less or 80% by weight or less. If the content of the negative electrode active material is less than 40% by weight, the electrical properties may be not sufficient, and if the content of the negative electrode active material is more than 80% by weight, the mass transfer resistance may increase.

The negative electrode layer binder may be of the same type and amount as the positive electrode binder, previously described herein. is the same as described above for the positive electrode active material layer.

Further, the conductive material is the same as described above for the positive electrode active material layer.

The negative electrode current collector is not particularly limited so long as it does not cause chemical changes in the corresponding battery and has conductivity. For example, the negative electrode current collector may be made of copper, stainless steel, aluminum, nickel, titanium, fired carbon, copper or stainless steel that is surface-treated with one of carbon, nickel, titanium, silver, or the like, an aluminum-cadmium alloy, or the like. Further, similar to the positive electrode current collector, the negative electrode current collector may be used in various forms such as a film, a sheet, a foil, a net, a porous body, a foaming body, and a non-woven fabric structure, which fine protrusions and depressions are formed on a surface thereof.

The preparation method of the negative electrode is not particularly limited, and it can be prepared by forming a negative electrode active material layer on a negative electrode current collector using a layer or film forming method commonly used in the art. For example, methods such as compression, coating, and deposition can be used. Further, the negative electrode of the present disclosure also includes a case in which a battery is assembled in a state where a lithium thin film does not exist on the negative electrode current collector, and then a metallic lithium thin film is formed on a metal plate through initial charging.

According to still another embodiment, there are provided a battery module including the all-solid state battery as a unit cell, a battery pack including the battery module, and a device including the battery pack as a power source.

Particular examples of the device may include, but are not limited to power tools driven by an electric motor; electric cars, including electric vehicles (EV), hybrid electric vehicles (HEV), plug-in hybrid electric vehicles (PHEV), or the like; electric carts, including electric bikes (E-bikes) and electric scooters (E-scooters); electric golf carts; electric power storage systems; or the like.

In view of the above, it will be seen that the several advantages of the invention are achieved, and other advantages attained.

Hereinafter, preferred examples are presented to help understand the invention, but the following examples are provided only to make the invention easier to understand and the invention is not limited thereto.

### Examples

### Example 1: Preparation of Composite Solid Electrolyte and all-Solid-State Battery

### Step 1) Preparation of Polymer Containing Copolymer

A polyethylene oxide (PEO)-based copolymer of the following formula 1a was prepared:

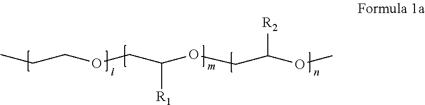

In Formula 1a, R₁ is —CH₂O—(CH₂—CH₂—O)ₖ—CH₃, R₂ is —CH₂—O—CH₂—CH═CH₂, k is 2, The ratio of l:m:n is 85:13:2, and the weight average molecular weight (Mw) of the copolymer was about 2,000,000 g/mol.

The copolymer of Formula 1a has an allyl group as a cross-linkable functional group bonded through a methylene oxide linker.

A mixture was formed with the polyethylene oxide (PEO)-based copolymer, acetonitrile as a solvent, trimethylolpropane trimethacrylate as a crosslinking agent, benzoyl peroxide as an initiator, lithium salt LiTFSI, and LSTP as a ceramic compound. This mixture was stirred using a magnetic bar for 24 hours. At this time, the polyethylene oxide composition of the mixed solution of copolymer and ceramic compound is polyethylene oxide. The mixture was composed such that for 100 parts by weight of the copolymer, 20 parts by weight of trimethylolpropane trimethacrylate, 1 part by weight of benzoyl peroxide, 36 parts by weight of LiTFSI, and 40 parts by weight of LSTP, were included. The concentration of the copolymer in the mixture is 11.1% by weight, and the acetonitrile solvent was used so that the concentration of the copolymer and ceramic compound in the mixture was 14.9% by weight.

After casting the prepared mixture onto the coin cell lower substrate, it was first dried at room temperature for 12 hours and then placed in a vacuum oven at 100° C. for 12 hours. Secondary drying was conducted in a vacuum oven (<10⁻² Torr) at 100° C. for 12 hours to ensure complete removal of residual solvent. The resulting electrolyte membrane had an approximate thickness of 200 μm.

### Step 2) Preparation of Composite Solid Electrolyte

The polymer is attached to the upper plate of the chamber, the lower part of the chamber is filled with 50 μl of ethyl methyl carbonate (EMC) solvent, and then it is naturally evaporated at room temperature for 72 hours. The EMC vapor is introduced into the inside of the polymer attached to the upper part of the chamber and deposited on the polymer. Thus, a composite solid electrolyte was prepared.

Step 3) Manufacturing of all-Solid-State Battery (Electrode Assembly)

NCMA (LiNi_{0.85}Co_{0.05}Mn_{0.08}Al_{0.02}O₂) as positive electrode active material particles (particle size: 5-10 μm, LG CHEM, Republic of Korea), superconductive carbon (C-65) conducting material, cross-linked PEO-based copolymer of formula 1a as used in step 1, LiTFSI were combined in a weight ratio of 77.6:3:14.2:5.2 and added to an acetonitrile solvent. The mixture was stirred using a paste mixer at 1500 rpm for 3 minutes at room temperature 5 times. The prepared mixed solution was cast on aluminum foil, first dried at room temperature for 6 hours, and then secondarily dried at 100° C. for 12 hours to prepare a positive electrode film with a thickness of 60 μm. After punching the positive electrode film with a mass loading of 6.712 mg/cm², the prepared composite solid electrolyte was used as the electrolyte film and lithium metal foil (300 μm) was used as the negative electrode, and the coin cell was manufactured by stacking them in a sandwich type.

### Example 2: Preparation of Composite Solid Electrolyte and all-Solid-State Battery

In the step 2) in the Example 1, the polymer is attached to the upper plate of the chamber, the lower part of the chamber is filled with 300 μl of ethyl methyl carbonate (EMC) solvent, and then it is naturally evaporated at room temperature for 72 hours. The EMC vapor is introduced into the inside of the polymer attached to the upper part of the chamber and deposited on the polymer. Thus, a composite solid electrolyte was prepared.

The remaining steps were performed in a similar manner to the Example 1.

### Comparative Example 1: Manufacturing of Composite Solid Electrolyte and all-Solid-State Battery

A composite solid electrolyte and an all-solid-state battery were manufactured in the same manner as those manufactured in Example 1, except that step 2) of vapor deposition of the EMC solvent in Example 1 was not performed.

### Comparative Example 2: Preparation of Electrolyte and Battery

The electrolyte films according to the Comparative Example 2 was prepared by an identical method to the step 1) in the Example 1.

The liquid solvent was directly injected into the electrolyte film without performing the step 2) in the Example 1 (i.e., without vapor deposition of the EMC solvent). The EMC solvent was directly injected so that the content of the EMC solvent was 12 wt. %, based on the total weight of the prepared electrolyte.

The remaining steps were performed in a similar manner to the Example 1.

### Experiment Examples

### Experimental Example 1: Measurement of Content of Polar Compounds

The content of the polar compound can be measured by using a scale to monitor the weight loss from a electrolyte specimen by evaporation of the polar compound over time while heating the composite solid electrolyte specimen. For example, the weight of the polar compound released from the specimen by evaporation over time can be monitored during heating the specimen at a temperature of from 55° C. to 110° C. (higher than boiling point of the polar compound) using a heated electronic scale (A&D MS-70 moisture analyzer). When the amount reached saturation point, the point where no more weight loss is monitored, the saturation amount at that time was regarded as the total amount of polar compound contained within the composite solid electrolyte. In Examples and Comparative Examples, the polar compound may be ethylmethyl carbonate (EMC).

Table 1 below shows the measurement results of the content of the EMC vapor-deposited (or included) in the electrolyte.

TABLE 1

| | EMC content (wt. %) based on the total |
|---|---|
| | weight of solid electrolyte |
| Example 1 | 1.2 |
| Example 2 | 6 |
| Comp. Example 1 | 0 |
| Comp. Example 2 | 12 |

### Experimental Example 2: Measurement of Ion Conductivity of Composite Solid Electrolyte

In order to measure the ionic conductivity of the composite solid electrolyte prepared in the Example and Comparative Example, the composite solid electrolyte was formed on the lower substrate of a coin cell with a size of 1.7671 cm² and then SUS was used as an inactive electrode (blocking electrode). A coin cell for measuring ionic conductivity was manufactured.

Resistance was measured using an electrochemical impedance spectrometer (EIS, VM3, Bio Logic Science Instrument) at 25° C. with an amplitude of 10 mV and a scan range of 1 Hz to 0.1 MHz, and then using Equation 1 below, the ionic conductivity of the composite solid electrolyte was calculated.

$${σ}_{i} = \frac{L}{RA} \qquad [ Equation 1 ]$$

In Equation 1, σi is the ionic conductivity of the composite solid electrolyte (S/cm), R is the resistance of the composite solid electrolyte (Ω) measured with the electrochemical impedance spectrometer, and L is the thickness of the composite solid electrolyte (μm), and A means the area of the composite solid electrolyte (cm²). The composite solid electrolyte sample was used with L=200 μm and A=1.7671 cm².

The ionic conductivity of Examples and Comparative Examples measured in accordance with the above-described method are shown in Table 2 below.

TABLE 2

| | Ionic conductivity |
|---|---|
| | (@25° C.; mS/cm) |
| Example 1 | 1.31 |
| Example 2 | 0.67 |
| Comp. Example 1 | 0.14 |
| Comp. Example 2 | 0.38 |

### Experiment Example 3: Measurement of Activation Energy by Temperature of Composite Solid Electrolyte Layer

Measuring the ionic conductivity of the composite solid electrolyte film at each temperature, by fitting the relationship between log (σi) and 1000/T using the Arrhenius equation below, Eₐ corresponding to the slope is calculated.

$${σ}_{i} = {σ}_{i , 0} exp [ - \frac{{E}_{a}}{RT} ]$$

In the above equation σ_{i,0} is the maximum ionic conductivity of the solid electrolyte, Eₐ is the activation energy, R is the gas constant, and T is the absolute temperature.

### Experiment Example 4: Evaluation of Thickness Strain Rate During Rolling for Anode

The positive electrode film with a thickness of 60 μm prepared in Example 1 was passed through a roll-to-roll mill and roll pressed to reduce the voids between active materials. The gap of the nip roll was gradually reduced and the thickness of the anode film at each gap was measured and the ratio of the thickness of the positive electrode film as a function of the roll gap to the film thickness before rolling was calculated, respectively. The values of C and n in Equation 2 below were determined by regressing the ratio of the gap between the rolls versus the thickness of the positive electrode film.

$$\frac{d}{{d}_{0}} = C {( \frac{{δ}_{0}}{δ} )}^{- n} \qquad Equation 2$$

wherein in Equation 2 above, δ₀ and d₀ indicates the initial roll gap and initial thickness of the positive electrode before rolling, δ and d represents the roll gap and the thickness of the positive electrode during rolling, C and n are constants determined by regression analysis.

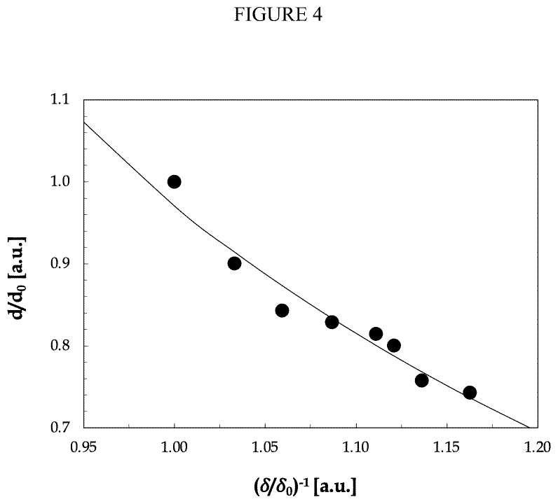

The relationship between the roll gap ratio and the positive electrode film thickness ratio as shown in FIG. 4.

### Experiment Example 5: Charge/Discharge Test for all-Solid-State Battery

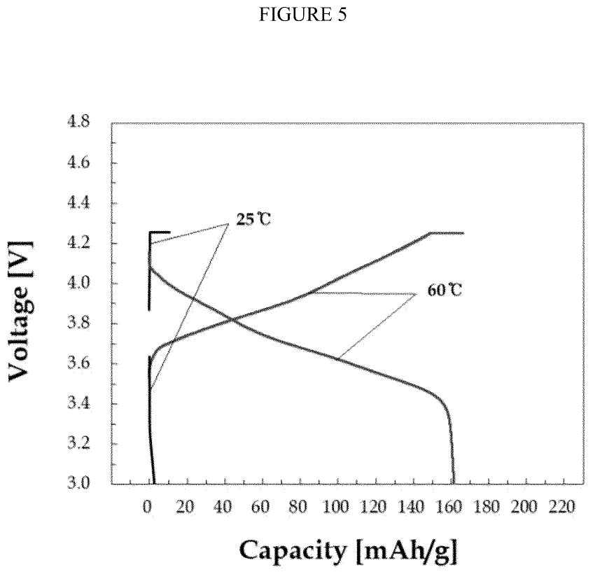

To evaluate the galvanostatic cycling characteristics of the manufactured all-solid-state battery, charging and discharging of the battery was repeated in the voltage range of 3.0-4.25 V using a TOSCAT charge/discharge tester (TOYO SYSTEM Co. Ltd., Japan). The charge/discharge test of the all-solid-state battery composite solid electrolyte of the Example was conducted at room temperature (25° C.) at a charge/discharge rate of 0.03C, and the all-solid-state battery containing the composite solid electrolyte of the comparative example without a polar solvent was tested at 25° C. and 60° C. Charge and discharge tests were conducted under the same conditions. These results are shown in FIG. 5.

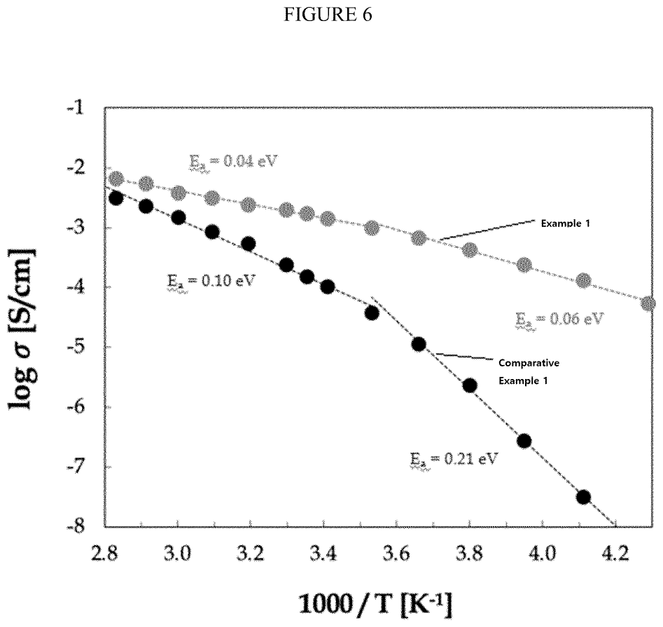

From the measurement and evaluation results of Experiment Examples 2 and 3, the results of evaluating the activation energy and log (ionic conductivity) of the composite solid electrolyte layers included in the Examples and Comparative Examples at each temperature are shown in comparison with FIG. 6.

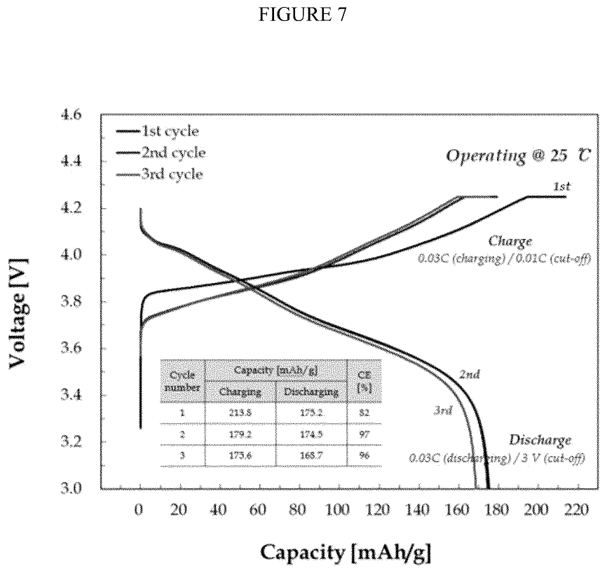

In addition, From the evaluation results of Experiment Example 5, The results of the room temperature charge/discharge test of the all-solid-state battery of the Example are shown in FIG. 7, The results of charge/discharge tests of the all-solid-state battery of the comparative example at room temperature and high temperature (60° C.) are shown in FIG. 5, as noted above.

Referring to FIG. 6, the composite solid electrolyte included in the all-solid-state battery of the Example not only has a lower variation in activation energy with temperature compared to the Comparative Example, it was confirmed that it exhibits excellent ionic conductivity as well.

Also, referring to FIG. 7, while the all-solid-state battery of the Example shows excellent charge and discharge characteristics at room temperature, it was confirmed from the FIG. 5 that the all-solid-state battery of the Comparative Example was practically impossible to operate at room temperature.

As various changes could be made in the above methods and compositions without departing from the scope of the invention, it is intended that all matter contained in the above description shall be interpreted as illustrative and not in a limiting sense.

Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

1. An electrode assembly comprising:
a positive electrode;
a negative electrode; and
an electrolyte layer between the positive electrode and the negative electrode,
wherein the electrolyte layer comprises: a polymer in the form of a network including a polyethylene oxide-based copolymer with cross-linkable functional groups, at least some of which form cross-links; a ceramic compound; and a polar compound,
wherein the polar compound is contained in the network, and
wherein the positive electrode comprises a positive electrode active material and a binder comprising the polymer including the polyethylene oxide-based copolymer having the cross-linkable functional groups.

2. The electrode assembly of claim 1, wherein the polar compound is in a gaseous state and dispersed between cross-linked polymer chains or is adsorbed or bound to the surface or interior of the polymer chains.

3. The electrode assembly of claim 1, wherein at least some of the cross-linkable functional groups form cross links with each other through a cross-linking agent.

4. The electrode assembly of claim 1, wherein the cross-linkable functional groups are connected to a main chain of the polyethylene oxide-based copolymer via a direct bond or a linker having a 1 to 10 carbon number, and
wherein the cross-linked functional groups are selected from the group consisting of a hydroxyl group, a carboxyl group, an isocyanate group, a nitro group, a cyano group, an amine group, an amide group, an epoxy group and an allyl group.

5. The electrode assembly of claim 4, wherein the linker is an alkylene linker or an alkylene oxide linker.

6. The electrode assembly of claim 1, wherein the electrolyte has an ionic conductivity of 0.95 mS/cm or more at 25° C.

7. The electrode assembly of claim 1, wherein at least one of the electrolyte layer or the positive electrode further includes a lithium salt.

8. The electrode assembly of claim 7, wherein the lithium salt is included in an amount of 25 to 45 parts by weight, based on 100 parts by weight of the polyethylene oxide-based copolymer containing the cross-linkable functional group.

9. The electrode assembly of claim 1, wherein the polyethylene oxide-based copolymer is a copolymer comprising repeating units of the following formulas 1 to 3: 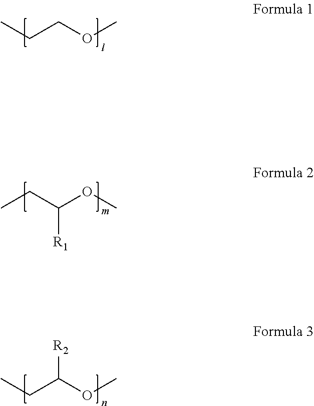
wherein in the above formulas 1 to 3, R₁ represents —CH₂—O—(CH₂—CH₂—O)ₖ—R₃, k is 0 to 20, and R₃ represents an alkyl group having 1 to 5 carbon atoms,
R₂ is a group in which at least one cross linkable functional group selected from the group consisting of hydroxyl group, a carboxyl group, an isocyanate group, a nitro group, a cyano group, an amine group, and an amide group, an epoxy group and an allyl group is bonded to a main polymer chain of the polyethylene oxide-based copolymer via a direct bond or a linker having a 1 to 10 carbon number, and
l, m, and n are the number of repetitions of the repeating unit, where 1 and n are each independently an integer from 1 to 1,000, and m is an integer from 0 to 1,000.

10. The electrode assembly of claim 9, wherein the linker is an alkylene linker or an alkylene oxide linker.

11. The electrode assembly of claim 1, wherein the polyethylene oxide-based copolymer is a copolymer comprising repeating units of Formula 4: 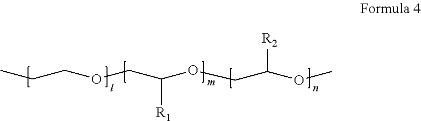
wherein R₁ and R₂ are the same or different from each other, and each is a group having at least one cross linkable functional group selected from the group consisting of: a hydroxyl group, a carboxyl group, an isocyanate group, a nitro group, a cyano group, an amine group, and an amide group, an epoxy group and an allyl group, and
l, m and n are each independently an integer from 1 to 1000.

12. The electrode assembly of claim 11, wherein R₁ and R₂ are different from each other.

13. The electrode assembly of claim 9, wherein R₁ and R₂ are different from each other, and one of R₁ and R₂ includes a cross-linkable functional group, and the other of R₁ and R₂ includes an oligomer acting as a plasticizer.

14. The electrode assembly of claim 9, wherein the copolymer has a weight average molecular weight (Mw) of 100,000 g/mol to 2,000,000 g/mol.

15. The electrode assembly of claim 1, wherein the content of the polar compound is 0.1% by weight or more and less than 10% by weight, based on the total weight of the solid electrolyte layer.

16. The electrode assembly of claim 1, wherein the polar compound includes at least one selected from the group consisting of carbonate-based compounds and sulfonyl-based compounds.

17. The electrode assembly of claim 1, wherein the polar compound comprises at least one selected from the group consisting of ethyl methyl carbonate (EMC), dimethyl carbonate (DMC), diethyl carbonate (DEC), ethylene carbonate (EC), propylene carbonate (PC), vinylene carbonate (VC) and sulfolane.

18. The electrode assembly of claim 1, wherein the ceramic compound comprises an oxide-based solid electrolyte of lithium metal oxide or lithium metal phosphate.

19. The electrode assembly of claim 16, wherein the ceramic compound is chosen from the group consisting of lithium-lanthanum-zirconium oxide(LLZO), lithium-silicon-titanium phosphate(LSTP), lithium-lanthanum-titanium oxide(LLTO), lithium-aluminum-titanium phosphate(LATP), lithium-aluminum-germanium phosphate(LAGP), and lithium-lanthanum-zirconium-titanium oxide(LLZTO).

20. The electrode assembly of claim 1, wherein the ceramic compound is in the form of particles having a diameter of 100 nm to 1000 nm.

21. The electrode assembly of claim 1, wherein the ceramic compound is included in an amount of 10 parts by weight to 100 parts by weight, based on 100 parts by weight of the polyethylene oxide-based copolymer.

22. The electrode assembly of claim 1, wherein the electrolyte layer has an activation energy deviation (ΔEa) by temperature defined by Equation 1 below of 0.03 eV or less:
$$Δ {E}_{a} = {{E}_{a}}^{LT} - {{E}_{a}}^{HT} , \qquad Equation 1$$
wherein in Equation 1 above, Eₐ^{LT} is the activation energy of the electrolyte layer at −40° C. to 10° C., Eₐ^{HT} is the activation energy of the electrolyte layer from 10° C. to 80° C., ΔEₐ represents the activation energy deviation by temperature, which is defined as the difference between the two activation energies.

23. The electrode assembly of claim 1, wherein the positive electrode satisfies the thickness strain defined by Equation 2 below when rolled on both sides using a roll:
$$\frac{d}{{d}_{0}} = C {( \frac{{δ}_{0}}{δ} )}^{- n} \qquad Equation 2$$
wherein in Equation 2 above, δ₀ and d₀ indicates the initial roll gap and initial thickness of the positive electrode before rolling, 6 and d represents the roll gap and the thickness of the positive electrode during rolling, C is a constant determined by regression analysis.

24. The electrode assembly battery of claim 1, wherein the negative electrode comprises a metal layer.

25. A battery comprising the electrode assembly of claim 1.
